(19) United States
(12) Patent Application Publication
(10) Pub. No.: US 2011/0272944 A1
(43) Pub. Date: Nov. 10, 2011

(54) ELECTRIC GENERATING DEVICE FOR TRAINING MACHINE

(76) Inventor: Huan Yao PENG, Hsin-Chu City (TW)

(21) Appl. No.: 12/904,860

(22) Filed: Oct. 14, 2010

(30) Foreign Application Priority Data
May 7, 2010 (TW) 99208600
Sep. 27, 2010 (TW) 99218626

(51) Int. Cl. F03G 5/06

(52) U.S. Cl. 290/50

(57) ABSTRACT

An electric generating device for a training machine is disclosed. The device has at least an electric generator, a trestle, and an electrical storage device electrically connectable to the generator. In one embodiment there are two electric generators that are mounted spaced apart in which the rotors and stators of the generators are symmetrically arranged. The rotor and stator of each side is separately connected to the corresponding rotor and stator of the other side through a rotor bushing and a bobbin. Each rotor is a hollow cylindrical disk that has multiple permanent magnets mounted on the inner surface of the disk and arrayed in circle. Each stator has multiple sets of generator coils and is mounted inside the disk and the permanent magnets. The stators of both sides are connected to a control plate through a connecting wire. The control plate has a series/parallel circuit, has a rectifier and has a voltage regulation circuit. The trestle has an adjusting knob.

### TECHNICAL FIELD OF THE INVENTION

The present invention relates in general to an electric generating device for a training machine, and relates in particular to an electric generating device which is connected to the training machine and generates electric power by the use of the training machine.

### BACKGROUND OF THE INVENTION

Conventional bicycles have employed electricity generators for some time. However, these generators merely provide electric power for bicycle systems, such as a bicycle lighting system. In such bicycle lighting systems, one end of an armature of an electric generator contacts a side wall of a bicycle tire wheel and is rotated as the wheel rotates. The other end of the armature has been mounted within a housing and is rotated between some permanent magnets, which produces an electromagnetic induction. This then produces an inductive current that is connected to the bicycle light, which then is illuminated.

In another type of bicycle generator of the prior art, the chain of the bicycle is used. The chain is elliptical or race track in shape and is rotated by the user pushing on the bicycle pedals. The chain also has a linear displacement. The linearly moving chain is in contact with and rotates a driving gear that is at one end of an armature. The rotating armature then generates electric power in an electric generator in the same way as the tire driven armature produces electricity.

Further, the generated electric power may be stored in a storage unit for providing electricity to an illuminating unit or other exterior electrical products, such as a horn. According to the above structure, it seems that the system is adequately self-supplied but the electrical energy produced from the mechanical energy in the system is only a small current. Such power is not enough for high power requiring products. In addition, such bicycle generator systems lacks serviceability.

### SUMMARY OF THE INVENTION

Considering the situation mentioned above, the inventor of the present invention invented an electric generating device for use with exercise and training machines. The training machines may be for example a stepper, an X-bike, a bicycle, a rowing machine, or a treadmill. The training machines are operated by the hands or feet of a user during doing an indoor exercise session. It is thus an object of the present invention to utilize the motion of the parts of a training machine to generate electric energy with a generator system according to the present invention.

The present invention provides either a single generator operated by the training machine or two or more generators electrically connected in a series circuit or a parallel circuit. If for example, the training device is an exercise bicycle, the tire wheel contacts a rotor bushing of an electric generator to produce tangential rotation. This rotation is used to rotate the moving parts of an electrical generator to yield electric power. The electric power is transmitted from the electric generator to a battery of an electrical storage device which stores the electric power. The present invention produces enough electricity that it may be employed in a large capacity electrical storage device and provides power to various electrical products. Thus the present invention not only uses the advantages of a training machine to produce fitness of the user, but also generates power, saves on other sources of electricity with a carbon free energy production.

The present invention in one embodiment for use with a training machine comprises an electric generator, a trestle in which the rear wheel a training bicycle is mounted, and a electrical storage device.

### BRIEF DESCRIPTION OF THE DRAWINGS

FIG. 1 is a perspective view depicting the structure of the electric generating device for a training machine, which is an exercise bicycle shown in light lines, of the first embodiment;

FIG. 2 is a perspective view depicting the an electric generator system, a trestle on which the generator system is mounted, and an electrical storage device of a first embodiment;

FIG. 3 is an exploded perspective view depicting the disassembled view of an electric generator system, a trestle, and an electrical storage device of the first embodiment;

FIG. 4 is a perspective view depicting an assembled electric generator of the first embodiment;

FIG. 5 is an exploded perspective view depicting the disassembled view of an electric generator of the first embodiment;

FIG. 6 is a perspective view depicting the structure of the electric generating device of a training machine of a second embodiment;

FIG. 7 is a perspective view depicting the assembled view of an electric generator, a trestle, and an electrical storage device of the second embodiment;

FIG. 8 is an exploded perspective view depicting the disassembled view of an electric generator, a trestle, and an electrical storage device of the second embodiment.

### DETAILED DESCRIPTION OF THE PREFERRED EMBODIMENTS

In order to explain the technique of the present invention clearly and completely, two embodiments according to the present invention will now be described in reference to the drawings wherein like numerals referring to likes parts throughout the drawings.

### The First Embodiment

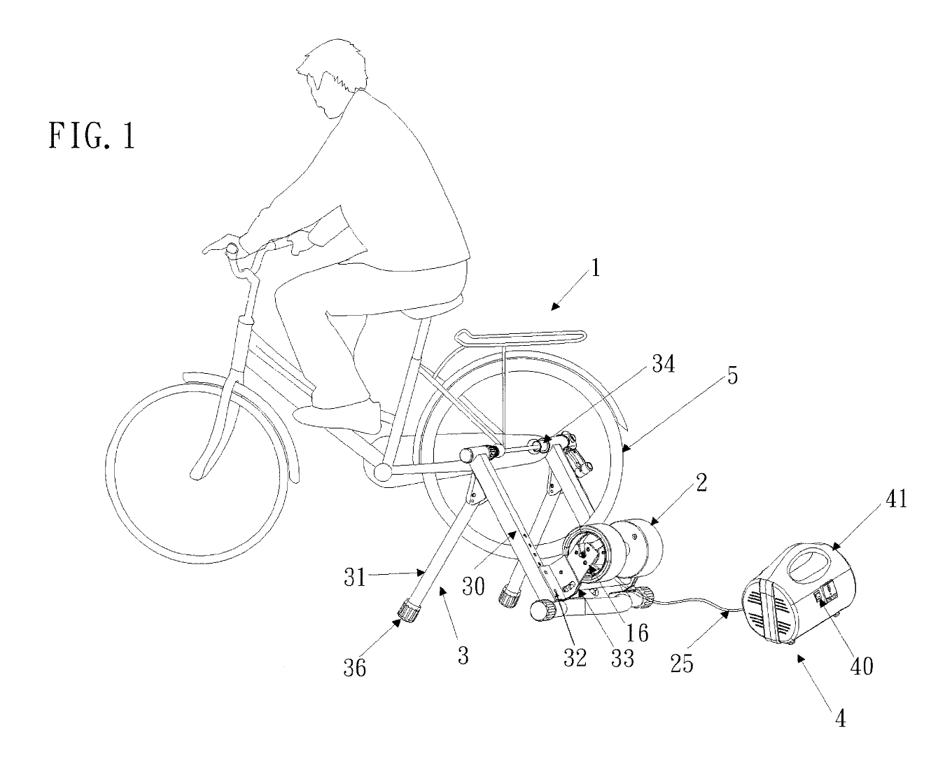

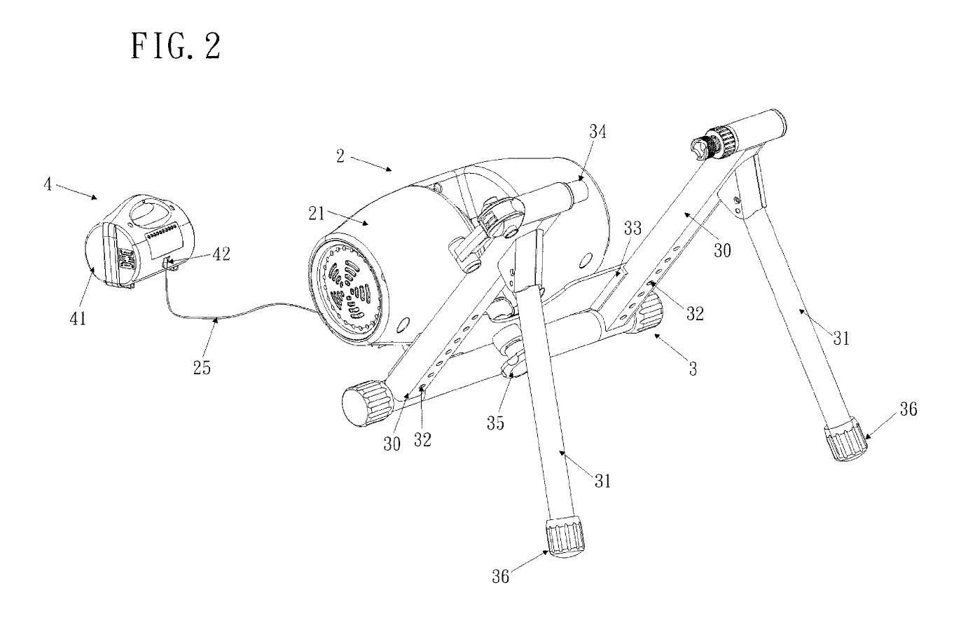

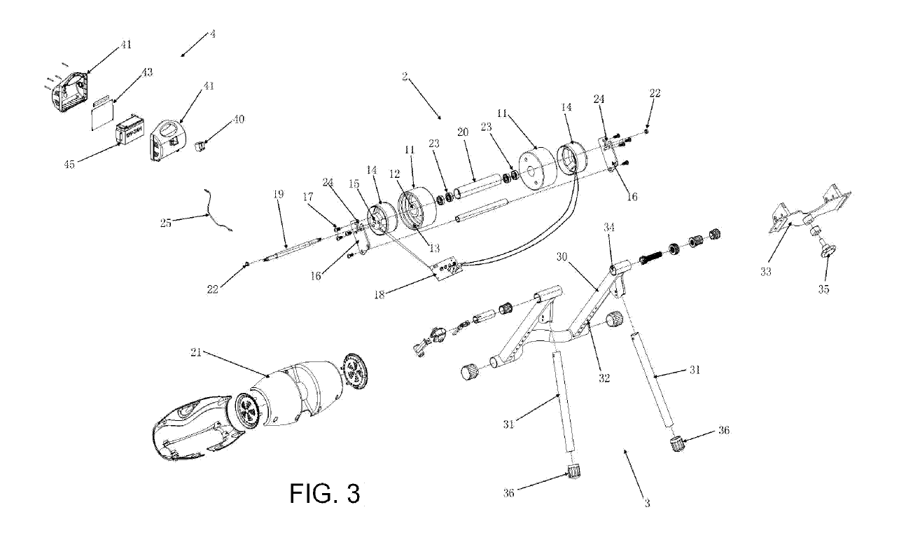

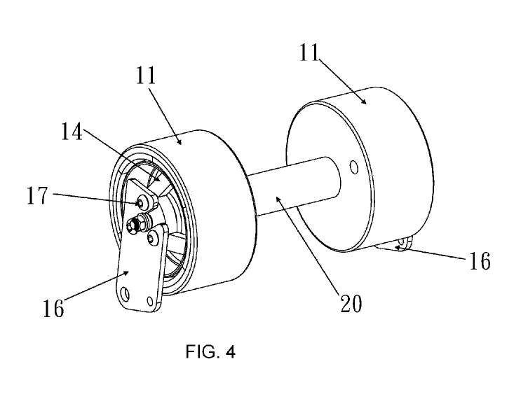

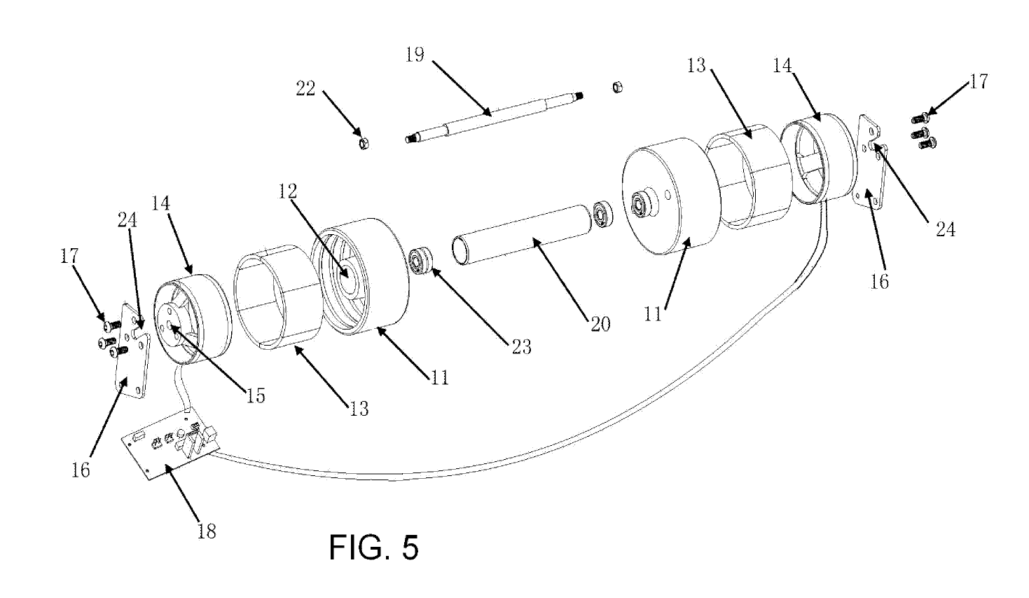

Referring now to FIG. 1 and FIG. 2, and FIG. 3, there is illustrated an electric generating device for a training machine. An electric generator system (2) (refer to FIG. 4 and FIG. 5) has a cabinet or housing (21) that contains inside separately an electric generator on the left side and one on the right side, as seen in the drawings.

Both electric generators can be used simultaneously in series/parallel. A rotor (11), and a stator (14) of an electric generator at one side are connected to symmetrically located rotor (11) and stator (14) of an electric generator at the other side through a rotor bushing (20) and a bobbin (19). The rotor (11) has a bushing hole (12) inside. The corresponding bushing holes (12) of both sides are connected by the rotor bushing (20) and shaft bearing (23), and the bobbin (19) is encased in the central hole of the rotor bushing (20). The rotor (11) has multiple permanent magnets (13) located at an inner wall surface and arrayed in circle. The stator (14) which contains several sets of generator coils is mounted inside rotor (11) and permanent magnets (13). A magnetron or mounting plate (16) is located outside of the stator (14) and has several studs (17). An axial hole (15) of the stator (14) is coupled or conjugated with the bobbin (19) which has screw-nut (22) at both ends for a fixed mounting or fixation. Two ends of the bobbin (19) are mounted at each side in a slot (24) of each magnetron plate (16), which in this embodiment is depicted as U-shaped. One side plate (16) has a control plate (18) which includes rectification and voltage regulation circuitry to supply stable current output after rectification. The symmetrical stators (14) of both sides are connected to a control plate (18) through a connecting wire. The control plate (18) has a series/parallel circuit and rectification, voltage regulation circuit etc. The control plate (18) also has a charging wire (25) which can be used to charge the battery 45.

A trestle (3), which comprises two fixing tubes (30) and two propping tubes to form a frame (31) is located outside of the electric generator system (2). The fixing tube (30) has multiple bolt holes (32) at both sides and a magnetron plate fixing frame (33) in the middle. The midpoint of the magnetron plate fixing frame (33) has an adjusting knob (35). The electric generator system (2) is fixed on both upper sides of the magnetron plate fixing frame (33). The lateral side of the magnetron plate fixing frame (33) is fixed to the fixing tube (30) by corresponding bolts in bolt holes (32) of the fixing tube (30). The central edge (34) of the trestle is fixed at the position of central edge of the training machine. One end of the propping tube (31) is fixed on a support surface, such as a floor through an overshoe (36), and the other end is fixed to the fixing tube (30). One end of each fixing tube (30) is fixed to corresponding ends of a lateral support tube that is supported by the floor. The other end of each fixing tube, above where the propping tube is connected, has an engaging coupling that can receive a respective end of a rear axle of bicycle (1).

According to the structure mentioned above, to meet the size of wheel tire (5), the user can adjust the position of the magnetron plate fixing frame (33) by moving and fixing it at different bolt holes (32) of the fixing tube (30); and then can slightly adjust the contact resistance of the wheel tire (5) by using an adjusting knob (35).

An electrical storage device (4) which has a sachet (42) and a switch (40) is movable and is located beside the electric generator to provide users with a choice of different voltages such as 100V/110V or 220V/250V. The electrical storage device has a PCB plate (43) and a battery (45) inside, and has been assembled and fixed by screws inside an external electrical storage device cabinet (41).

### The Second Embodiment

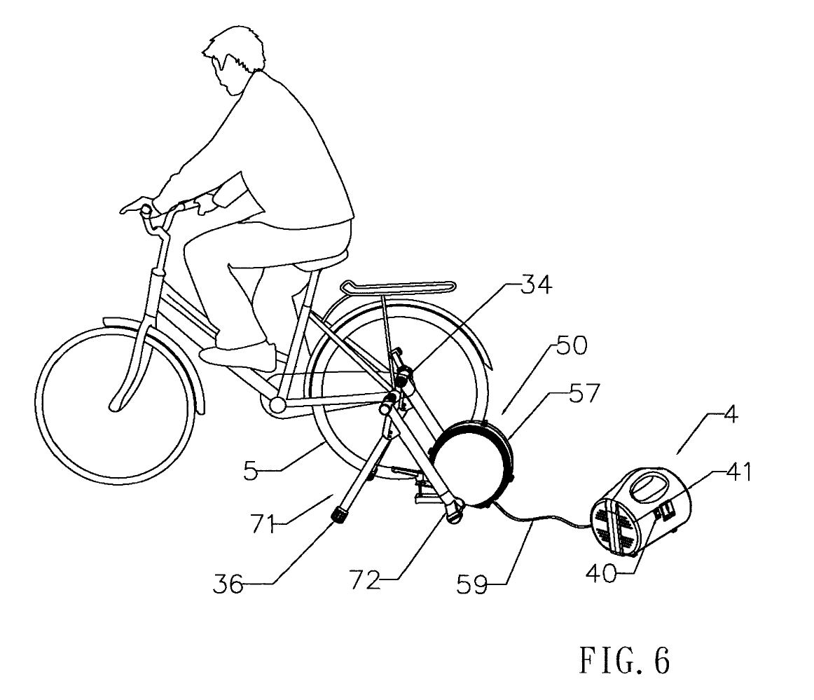

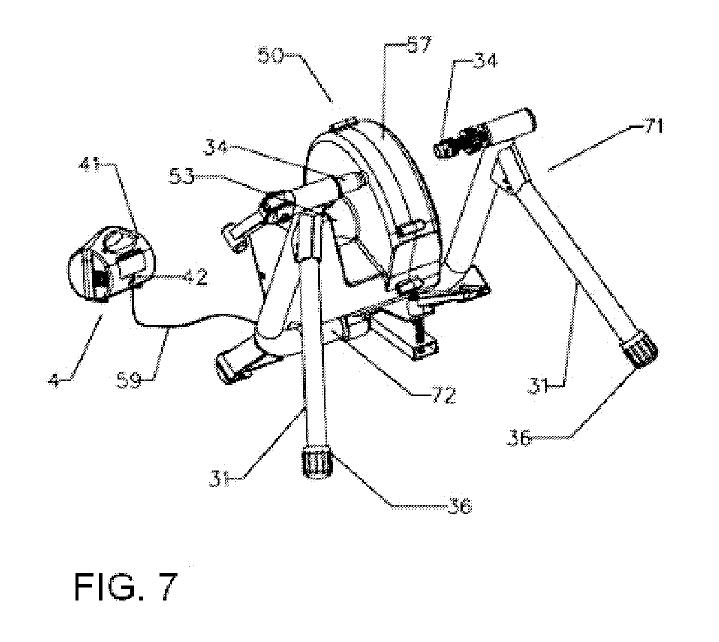

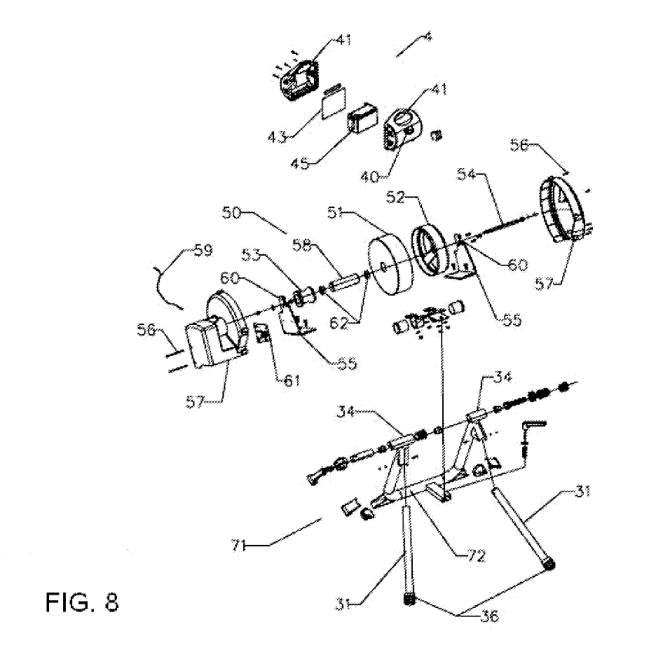

Referring now to FIG. 6 and FIG. 7, and FIG. 8, the structure of the electric generating device of training machine of the present invention is analogous to the first embodiment except that two electric generators of the electric generator system (2) in the first embodiment is changed to one electric generator (50). The electric generator (50) (refer to FIG. 8) has multiple permanent magnets as rotors (51), and the stator (52) which has several sets of generator coils is located inside the permanent magnets (51). A bush (58) is connected to the central hole of the rotor (51), and a rotor bushing (53) is encased outside of the bush (58). The bush (58) has pass holes inside; shaft bearing (62) is installed at pass holes of two ends separately. A bobbin (54) goes in the center of the bush (58) and both ends of the bobbin (54) are mounted in U-shape slot (60) of the magnetron bed (55) and fixed therein. The lateral side of the magnetron bed (55) has a control plate (61) which has rectification and voltage regulation function to deliver stable current after rectification. The control plate (61) also has a charging wire (59). Exterior part of the electric generator (50) is assembled and fixed by screw (56) and a cabinet (57).

A trestle (71) has a main frame (72) and a propping tube (31). The main frame (72) is used to fix or mount electric generator (50). The central edge (34) of the trestle is fixed at the bobbin position of the wheel center. As described in the first embodiment, an electrical storage device (4) is located beside the electric generator (50).

The training machine of the first embodiment and the second embodiment mentioned above may be a stepper, an X-bike, a bicycle, a rowing machine, or a treadmill etc. and is operated manually by hands or feet of a user during doing indoor exercise. The users of the training machine may choose either the mode of the first embodiment e.g. series circuit/parallel circuit or the mode of the second embodiment. By pedaling with feet or hands, the wheel tire (5) contacts with a rotor bushing (20)(53) of the electric generators (2)(50) to do tangential rotation. The rotation further carries rotors (11)(51) to spin, and then the stators (14)(52) yield electric power.

The electric power is transmitted to a control plate (18) of the electric generator (2)(50) and charged into a battery (45) through a PCB plate (43) of a electrical storage device (4) after rectification and voltage regulation; or the electric power may be also employed to a large capacity electrical storage device (4) for charging. Thus the capability of the electric generators (2)(50) may maximize.

Consequently, the training machine of the present invention provides body fitness for the users, and at the same time also yields electric power when using the training machine indoor. The electric power yielded by the electric generators (2)(50) may be transmitted to the electrical storage device (4) to be stored. The most important characteristic of this electric generating device would be simulating large or small torque of the training machine, and then causing electric generating and charging. The electric power stored in the battery (45) of the electrical storage device (4) is output through a PCB plate (43) as a power source for electric products (may provide various voltages e.g. 100V˜250V). Briefly the present invention not only enhances the effectiveness of an indoor training machine, but also gains objects of fitness, power-saving, energy-saving, and carbon-reduction.

Various kinds of training machine can be operated by hands or feet or both of a user and may produce large and small torques in different exercise situations. The present invention can have a single circuit or a selectable series circuit or a parallel circuit. The electric power yielded at exercise can be stored in an electrical storage device and delivered therefrom at different voltages from 100V to 250V through a PCB to electric products.

The intention of the present invention is to provide an electric generating device of a training machine. Having illustrated and described the principles of my invention by what are presently preferred embodiments, it should be apparent to those persons skilled in the art that the illustrated embodiment may be modified without departing from such principles.

While a preferred embodiment of the device, together with alternate embodiments of the device, have been shown and described, it will be understood that there is no intent to limit the invention by its disclosure, but rather it is intended to cover all modifications and alternate constructions falling within the spirit and the scope of the invention as defined in the appended claims.

### IDENTIFICATION OF THE ELEMENTS PRESENTED IN THE DRAWINGS

### The First Embodiment

| | | | |
|---|---|---|---|
| 2 | electric generator | 3 | trestle |
| 4 | electrical storage device | 5 | tire |
| 11 | rotor | 12 | bushing hole |
| 13 | permanent magnet | 14 | stator |
| 15 | axial hole | 16 | magnetron plate |
| 17 | stud | 18 | control plate |
| 19 | bobbin | 20 | rotor bushing |
| 21 | cabinet | 22 | screw-nut |
| 23 | shaft bearing | 24 | U-shape slot |
| 25 | charging wire | 30 | fixing tube |
| 31 | propping tube | 32 | bolt hole |
| 33 | magnetron plate fixing frame | 34 | central edge |
| 35 | adjusting knob | 36 | overshoe |
| 40 | switch | | |
| 41 | electrical storage device cabinet | | |
| 43 | PCB plate | 45 | battery |

### The Second Embodiment

| | | | |
|---|---|---|---|
| 50 | electric generator | 51 | Rotor |
| 52 | stator | 53 | rotor bushing |
| 54 | bobbin | 55 | magnetron bed |
| 56 | screw | 57 | cabinet |
| 58 | bush | 59 | charging wire |
| 60 | U-shape slot | 61 | control plate |
| 62 | shaft bearing | 71 | trestle |
| 72 | main frame | | |

1. An electric generating device operable by a training machine, comprising:
An electric generator system which includes
at least a first electric generator having
a rotor comprised of a circular shell having an inner wall surface and a multiple number of permanent magnets located and arrayed on the inner wall surface, and
a stator comprised of several sets of generator coils and mounted inside said rotor inner wall and said permanent magnets;
a trestle that is comprised of:
a fixing tube on which the electric generator is mounted; and
a propping tube having a first end that can engage a floor and a second end fixed to the fixing tube; and
an electrical storage device for storing the electricity produced by the generator.

2. The electric generating device as claimed in claim 1, and further comprising a second generator also mounted on said trestle, said second generator being spaced laterally apart from the first generator, said second generator also having
a rotor comprised of a circular shell having an inner wall surface and a multiple number of permanent magnets located and arrayed on the inner wall surface, and
a stator comprised of several sets of generator coils and mounted inside said rotor inner wall and said permanent magnets; and
said trestle has another fixing tube on which the second electric generator is mounted; and has another propping tube with a first end that can engage a supporting surface such as a floor and a second end fixed to the other fixing tube.

3. The electric generating device as claimed in claim 2, each said generator further comprising a rotor bushing and a bobbin each with two ends that respectively connect together the two rotors and the two stators of the generators, wherein the two ends of the bobbin are respectively mounted on a slot in a mounting plate at each side.

4. An electric generating device as claimed in claim 2, wherein said stators are symmetrical and are electrically connected to a control plate.

5. An electric generating device as claimed in claim 2, wherein each said mounting plate is in turn mounted on respective sides of said trestle, and a midpoint of the magnetron plate fixing frame has an adjusting knob that can adjust the height of said trestle; the electric generators are fixed on the upper sides of the mounting plate and the lateral side of the mounting plate fixing frame is fixed to the fixing tube.

6. An electric generating device as claimed in claim 2, wherein the electrical storage device has a PCB plate and a battery inside, and an electrical storage device cabinet containing said generating device.

7. An electric generating device as claimed in claim 2, wherein a left side and a right side of the electric generating system connect to an electric generator separately, two electric generators can be used in series or in parallel.

8. An electric generating device as claimed in claim 2 wherein the rotor bushing is mounted such that it can physically contact a tire of a training machine and can be rotated thereby whereby the two rotors are rotated thereby generating electric power in the stators.

9. An electric generating device of a training machine, comprising:
an electric generator which has multiple permanent magnets as rotor; the stator which has several sets of generator coil is inside the permanent magnets; the rotor connects to a bush; the bush is encased by a rotor bushing outside, and has a bobbin inside; two ends of the bobbin are mounted on U-shape slot at both sides of a mounting bed; the electric generator is assembled and fixed by screw and an outside housing.
a trestle which has a main frame that rigidly mounts the electrical generator, and has a propping tube for supporting the main frame from a support surface; and wherein the central edge of the trestle is fixed at the bobbin position of center of the wheel; and
an electrical storage device which is connectable to the electric generator.

10. An electric generating device as claimed in claim 9, wherein the lateral side of the magnetron bed has a control plate which has rectification, and voltage regulation function to supply stable current after rectification; the control plate has a charging wire.

11. An electric generating device of as claimed in claim 9, wherein the bush of the electric generator has pass holes inside; a shaft bearing is installed at pass holes of two ends separately.

12. An electric generating device as claimed in claim 9, wherein the rotor bushing contacts with the tire to do tangential rotation; the rotation further causes the rotors to spin, and then the stators produce electric power.

13. An electric generating device of a training machine, comprising:
an electric generator system which has a cabinet outside, and inside separately has one electric generator at left and right side; a rotor and a stator of an electric generator at one side are connected to symmetric rotor and stator of an electric generator at the other side through a rotor bushing and a bobbin; the rotor has a bushing hole inside; the counterpoised bushing holes of both sides are connected by the rotor bushing and a shaft bearing; the bobbin is encased in the central hole of the rotor bushing; the rotor has multiple permanent magnets located at inner wall surface and arrayed in circle; the stator which has several sets of generator coil is inside the permanent magnets; a magnetron plate is located outside of the stator and has several studs; axial hole of the stator is conjugated with the bobbin which has screw-nut at both ends for fixation;
a trestle which has a propping tube and a fixing tube for fixing the electric generator; the fixing tube has multiple bolt holes at both sides and a magnetron plate fixing frame at middle; the central edge of the trestle is fixed at the position of central edge of the training machine; one end of the propping tube is fixed on the floor through an overshoe, and the other end is fixed to the fixing tube; and
an electrical storage device which is located beside the electric generator, is movable and has sachet and switch; and is available for a user to choose voltage of 100V/110V or 220V/250V.
